(19) United States
(12) Patent Application Publication
(10) Pub. No.: US 2008/0116133 A1
(43) Pub. Date: May 22, 2008

(54) Method and Apparatus for Extracting Comtaminants from Water

(76) Inventor: Inge Brun Henriksen, Stavanger (NO)

Correspondence Address: NIXON & VANDERHYE, PC, 901 NORTH GLEBE ROAD, 11TH FLOOR, ARLINGTON, VA, 22203, US

(21) Appl. No.: 11/632,557

(22) PCT Filed: Jun. 17, 2005
(86) PCT No.: PCT/GB05/02411

§ 371 Date: May 15, 2007

(30) Foreign Application Priority Data
Jun. 18, 2004 (GB) 0413714.7

(51) Int. Cl. B01D 17/02; B01D 11/04

(52) U.S. Cl. 210/634; 210/511; 210/261; 210/134

(57) ABSTRACT

The present invention provides a method for mixing a liquefied hydrocarbon gas extracting a flow of hydrocarbon containing water. The method involves; a) introducing the liquefied hydrocarbon gas extracting into the water to provide water having entrained droplets of the extract and/or the hydrocarbon; b) subjecting the water to a first pressure drop to fragment the entrained droplets c) optionally, mixing the water and the liquefied hydrocarbon gas to promote distribution of the liquefied hydrocarbon gas in the water; and d) subsequently subjecting the water having entrained droplets to a second pressure drop, to coalesce the entrained droplets. The invention also provides a method for extracting contaminants involving the mixing method and apparatus suitable for carrying out the methods of the invention.

The present invention relates to an improved method for removing residual oil from produced water generated from oil wells. In particular, the present invention relates to a method for improving the performance of separators employing liquefied gasses to enhance such separation.

“Produced water” is the term used in the oil industry to indicate water which is co-produced with oil and/or gas. This water may comprise naturally occurring water underlying the gas or oil deposits (formation water) and may also comprise water which has been injected into the reservoir to help force the desired oil or gas to the surface. As the deposit becomes depleted, greater quantities of water are introduced and thus, as an oil bearing formation ages, the amount of produced water in the oil increases. This increase is particularly being seen in the northern North Sea, where the oil fields are relatively mature.

In 2001, around 120 million tonnes of produced water was generated in the Norwegian sector of the North Sea and 260 million tonnes in the UK sector. These numbers are expected to rise by around 20% per year.

As produced water is co-extracted from deposits with oil and/or gas it is unsurprising that, when this water is separated out, a considerable amount of residual organic material, particularly hydrocarbons remain. Some of this residual material is dispersed as droplets within the water and the remainder is held in solution. Generally, the more polar species, such as aromatics and phenols, have a greater aqueous solubility than saturated hydrocarbons and so form a greater proportion of the dissolved matter. Some produced water is injected back into underground formations but the bulk is disposed of by discharge into the sea.

The discharge of large volumes of produced water containing significant amounts of dispersed and/or dissolved oil or other organic compounds is not only wasteful of oil but potentially highly environmentally damaging. As a result, strict limits have been introduced to control the oil content of produced water discharged into the sea. In 1978, an international convention established a provisional target of 40 parts per million by weight (ppm) of oil in discharged water from offshore oil installations. This was, at the time, a target value based upon what was then technically feasible and has since been tightened, at least in the UK to being a maximum value permissible in order to obtain the legal exemptions required for water discharge. Furthermore, the UK offshore industry has now accepted a voluntary target of 30 ppm oil in produced water, as a annual average, with this figure expected to become compulsory around 2005. In addition in 2006, the legislation for the North Sea (OSPAR) calls for a 15% reduction in oil discharged to sea. The discharge at year 2000 is set as reference.

As well as the removal of dispersed oil from produced water, there is a considerable need for efficient removal of certain dissolved components, including soluble volatile oil components (SVOCs, which includes naphthalenes, polyaromatic hydrocarbons and phenols) and particularly certain aromatic benzene derivatives known as BTEX (Benzene, Toluene, Ethylbenzene and Xylene). These dissolved components are increasingly implicated as having environmental impacts and effects on marine organisms, including inducing poor quality sperm production and later egg laying in North Sea fish such as cod.

As can be seen from the above, there is a considerable environmental and regulatory need for efficient removal of dissolved and dispersed organic material from produced water prior to discharge.

One method by which the oil component of produced water may be separated out involves the use of hydrocyclones. These were originally proposed around 1980 and operate by spinning the fluid around the inside of a generally cylindrical or conical vessel to form a “cyclone”. This cyclone generates a centrifugal force causing more dense components to migrate to the outside of the cyclone and less dense components to concentrate in the middle. The dense salt water is thereby separated from the lighter organic fraction and the two fractions removed selectively.

As well as the hydrocyclones described above, a number of other separators and separation techniques exist but, in the majority of these, the principle remains the same; the oil is separated from the water the floatation of dispersed oil particles to the “top” of the bulk aqueous phase. This “top” may be defined by gravity, in the case of gravity separators, or may be the inside of a spinning column of fluid in the case of hydrocyclones.

For nearly 20 years, the design and efficiency of hydrocyclones and similar floatation type processes evolved in a gradual fashion. Since these methods separate on the basis of differences in density, the rate of separation is related to the density difference and the “drag” caused by the movement of particles of the dispersed phase through the continuous phase. This “drag” is related to the particle size (i.e. to the ratio of the volume and thus buoyancy to surface area) of the dispersed component (in this case the oil). Considerable improvements, of the order of 30 to 40%, were achieved over this time by minimising the oil droplet breakup by avoiding turbulent flows through pumps and valves upstream of the hydrocyclone or similar separator.

In spite of the improvements in separation achieved by minimising droplet breakup, the traditional design of separators such as hydrocyclones is scarcely able to achieve the low dispersed oil levels of 30-40 ppm now required. Furthermore, because the separators fractionate by particle density, there is negligible separation of the dissolved organic components from the produced water.

In hydrocyclones and in all similar methods of separation it has been considered essential that oil droplet size be maintained as large as possible to maximise the speed and efficiency of the floatation effect. All efforts are thus made to eliminate turbulent flows and position the separator up-stream of equipment that might induce droplet breakage.

A considerable advance in separator technology, which can overcome some of the limitations of traditional floatation type separators and hydrocyclones, was proposed in U.S. Pat. No. 6,077,433 (the disclosures of which are incorporated herein by reference). In the method described, a liquefied hydrocarbon gas is introduced into the produced water stream prior to the separation, which must then be carried out under conditions of pressure and temperature which maintain this hydrocarbon extractant in the liquid phase region. The advantages of this method are several. Firstly, the liquefied gas acts as a solvent for the dissolved organic material, which partitions out of the aqueous phase and is then removed with the liquefied gas at the separation stage. Secondly, the dispersed droplets of liquefied gas merge with the oil droplets to provide larger and thus more quickly separating drops. Additionally, the liquefied gas generally has a lower density than the dissolved and/or dispersed organic materials and thus drops containing liquefied gas separate more rapidly in the separator due to an enhanced density differential.

In spite of the considerable advances made in separation technology relating to the removal of organic compounds from produced water, there remains a need for further enhancement. In particular, an ever larger volume of produced water is being generated and the standards for discharged water purity are becoming increasingly strict. The space, cost, weight and environmental impact (in terms of energy consumed) of adding more and more traditional separators, acting in parallel to improve throughput and/or acting in series to improve separation, will increasingly become prohibitive in the context of offshore oil production facilities. There is thus an evident need for methods by which the efficiency of oil/water separators may be improved, both in terms of removal of dispersed oil and in terms of extraction of dissolved organic components. It would be particularly advantageous if such improvements could be implemented by minor alterations to existing techniques not adding significant complexity, cost or weight to the separation systems.

The present inventor has now, unexpectedly, established that, contrary to the established practice, the efficiency of certain separation systems may be improved by fragmenting the suspended oil droplets rather than, as is currently practiced, scrupulously maintaining their larger size. In particular, the present inventor has established that, by the use of two chokes in rapid succession, the droplets of organic material in produced water can be fragmented and subsequently re-coalesced to provide improved separation.

In a first aspect, the present invention thus provides a process for mixing liquefied hydrocarbon gas extractant with hydrocarbon containing water, said method comprising;
a) introducing said liquefied hydrocarbon gas extractant into said water;
b) subjecting said water to a first pressure drop whereby to fragment entrained hydrocarbon droplets e.g. by flowing said water through a first choke, thereby providing a first pressure drop whereby to break up said droplets;
c) optionally, mixing said water and said liquefied hydrocarbon gas whereby to promote distribution of said liquefied hydrocarbon gas in said water; and
d) subsequently subjecting said water to a second pressure drop whereby to coalesce entrained hydrocarbon droplets therein, e.g. by flowing said water through a second choke, thereby providing a second pressure drop whereby to coalesce said droplets.

The entrained droplets referred to herein may be, for example, droplets comprising contaminant organic material, droplets comprising liquefied hydrocarbon gas extractant, and/or mixed droplets resulting from the fusion of at least one droplet of liquefied hydrocarbon gas extractant with at least one droplet of contaminant organic material and thus comprising both materials.

While it is especially preferred that the extractant be dispersed in droplet from in the water before the first pressure drop, in alternative embodiments, the extractant can be introduced during the first pressure drop or between the first and second pressure drops. In a particularly preferred embodiment, further extractant may be introduced between the second pressure drop and a third pressure drop also functioning to promote coalescence of hydrocarbon droplets in the water, e.g. using a third choke. Fourth and further coalescence promoting pressure drops may be utilised if desired, as may further extractant introductions.

The method of the first aspect of the present invention is highly suitable for applications such as the removal of dispersed and/or dissolved hydrocarbon contaminants from water, particularly produced water.

In the method of the invention, step a) may be conducted prior to, simultaneously with and/or after step b). That is to say, the liquefied hydrocarbon gas extractant may be introduced at the point of the first pressure drop, in which case the means for imparting the first pressure drop (e.g. the first choke) will also be an injector device for the extractant, or may be introduced before (upstream of) the first choke and/or after (downstream of) the first choke. Introduction of at least part of the extractant upstream of the first pressure drop is preferred. Where at least a portion of the extractant is introduced after the first pressure drop (e.g. after the first choke), this will be sufficiently close that a maximum of a few seconds (e.g. less than 10 seconds, preferably less than 3 seconds and more preferably less than 1 second) will elapse on average between a droplet of dispersed contaminant passing the first choke and that droplet, or any resulting broken droplets, passing the point of introduction of the extractant. This is believed particularly significant due to the effects of droplet breakage discussed herein infra.

The method of the invention preferably also involves separating entrained hydrocarbon droplets from the water phase using a separator. The separator will preferably be a separator which operates by density difference. Preferred separators are float separators and particularly hydrocyclone separators. In one aspect, the invention thus provides a method of extracting dispersed and/or dissolved contaminants, especially organic contaminants such as hydrocarbons, from water containing such contaminants, wherein the method comprises the mixing method of the invention, preferably followed by at least one separation step as described.

Where the method of the invention involves fragmentation of the extractant, the effect of this fragmentation is to provide a very high surface area at which transfer/partitioning of the dissolved organic contaminants from the aqueous phase to the extractant can take place. Thus, during the period between the fragmentation inducing pressure drop and the coalescence promoting pressure drop, the dissolved contaminant is exposed to a large surface area of extractant in the form of broken droplets, whereby some or all of the dissolved contaminant is extracted from the water. The later handling and separation of the extractant is then promoted by the coalescence of the broken droplets into larger droplets. The nature of the broken droplets may also aid extraction of dissolved material, as described herein infra.

It will be evident to one of skill in the art that in most situations, contaminated water (particularly produced water) will contain both dispersed and dissolved organic contaminants.

In the method of the invention, the act of introducing the extractant into a water flow will often be sufficient to distribute the extractant in the water and no further mixing will be necessary. Similarly, where the extractant is introduced prior or simultaneously to the first pressure drop, the effect of this pressure drop may be sufficient to provide efficient mixing of the extractant droplets in the water. Where further mixing is necessary, particularly for example in a larger pipe or where lower flow rates are anticipated, a mixing step will preferably be included. This will preferably be carried out after introduction of the extractant and/or after the first pressure drop, preferably before the second pressure drop.

In the method of the invention it is important to ensure that first and second pressure drops effectively achieve their respective tasks of breaking and coalescing the droplets of suspended organic phase (extractant and/or contaminant). These effects can be achieved by appropriate selection of the magnitude of the pressure drops (e.g. across the first and second chokes) and the interval (e.g. spacing) between them. The method may thus additionally comprise the following steps;
i) assessing a first rate of flow of water at around the point of the first pressure drop;
ii) adjusting the first pressure drop (e.g. by adjusting the first choke) by reference to the assessed first rate of flow of water, whereby to maintain the effect of breaking up the droplets of dispersed extractant and/or contaminant at the first pressure drop;
iii) assessing a second rate of flow of water at around the point of the second pressure drop;
iv) adjusting the second pressure drop (e.g. by adjusting the second choke) by reference to the assessed second rate of flow of water, whereby to maintain the effect of coalescing the droplets of dispersed extractant and/or contaminant at the second pressure drop;

The assessment of the flow of water at steps i and iii) may be by any suitable means including direct flow measurement, or measurement of the magnitude of the appropriate pressure drop (e.g. across the appropriate choke). Similarly, it may be possible to use “self adjusting” type chokes which will completely or sufficiently compensate for changes in flow rate/pressure drop such that no further intervention is necessary to maintain pressure drops within the desired range.

In a further aspect, the present invention provides an apparatus comprising a conduit (e.g. a pipe) suitable for accepting a flow of water, optionally containing dispersed droplets of organic contaminants, the apparatus further comprising;
an injector suitable for introducing a liquefied hydrocarbon gas extractant into said flow of water in the form of dispersed droplets of extractant;
a first choke capable of providing a first pressure drop;
optionally a mixer;
a second choke capable of providing a second pressure drop.

wherein said first and second pressure drops are provided such that in use the droplets of extractant and/or contaminant are broken as a result of passing through the first pressure drop and are coalesced as a result of passing through the second pressure drop.

In a still further aspect, the present invention provides an apparatus suitable for separating dissolved and/or dispersed organic contaminants from water, said apparatus comprising a conduit (e.g. a pipe) suitable for accepting a flow of water, and further comprising;
a) an injector suitable for introducing a liquefied hydrocarbon gas extractant into said flow of water in the form of dispersed droplets of extractant,;
b) a first choke capable of providing a first pressure drop;
c) optionally a mixer;
d) a second choke capable of providing a second pressure drop.
e) a separator suitable for separating said liquefied hydrocarbon gas from said water.

wherein said first and second pressure drops are provided such that in use the droplets of extractant and/or contaminant are broken as a result of passing through the first pressure drop and are coalesced as a result of passing through the second pressure drop.

The various apparatus of the invention may additionally comprise;
i) a device capable of reacting to a first rate of flow of water through the first choke;
ii) a device capable of adjusting the first choke by reference to the reaction provided at step i);
iii) a device capable of reacting to a second rate of flow of water through the second choke;
iv) a device capable of adjusting the second choke by reference to the reaction provided at step iii).

whereby in use the first and second pressure drops are maintained such that the droplets of extractant and/or contaminant are broken as a result of passing through the first pressure drop and are coalesced as a result of passing through the second pressure drop over a wide range of flow rates.

In a yet still further aspect, the present invention provides the use of an apparatus as described herein in the separation of dissolved and/or dispersed organic material from water, especially produced water.

The invention will now be described in greater detail in the following general description and non-limiting examples and by reference to the attached figures, in which;

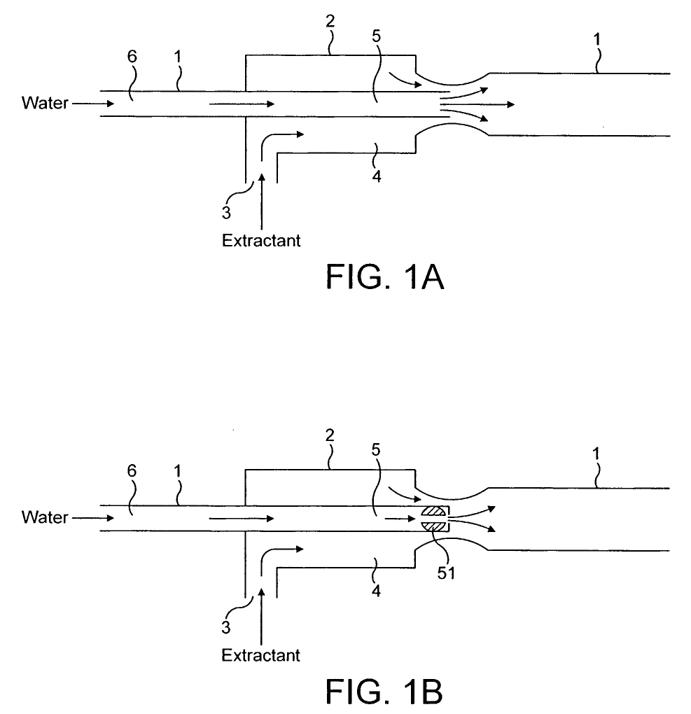

FIG. 1 a Shows a schematic choke suitable for use in the invention;

FIG. 1b Shows a further choke and injector suitable for use in the invention;

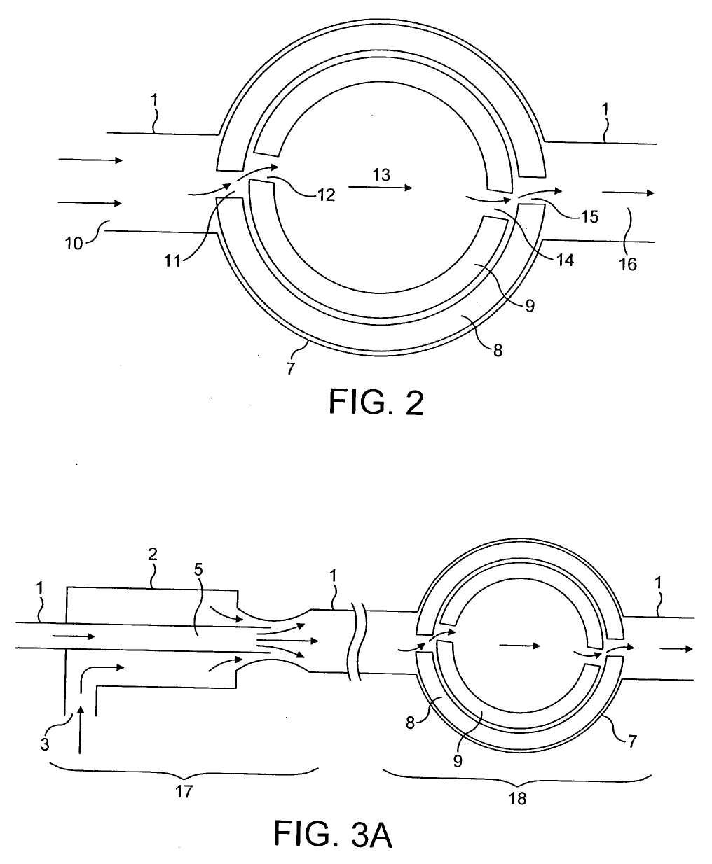

FIG. 2 Shows a choke suitable for use in the invention;

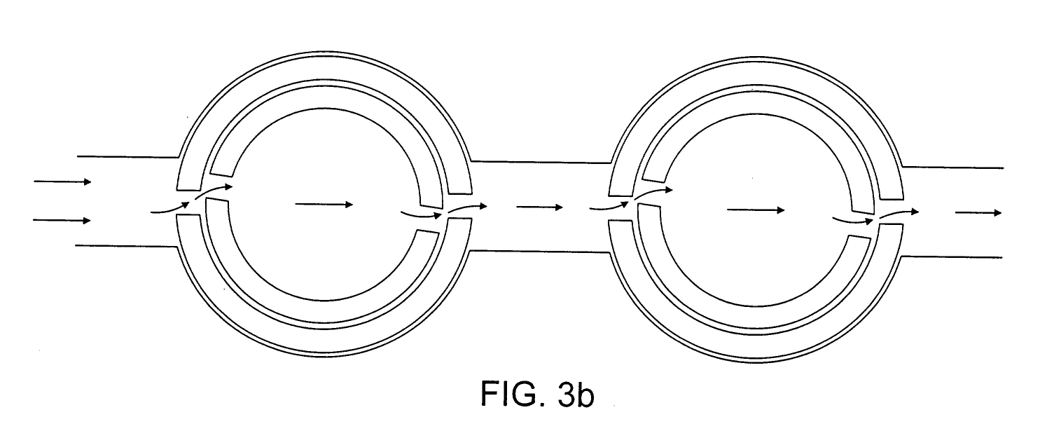

FIG. 3a Shows a schematic example dual choke system;

FIG. 3b Shows a further dual choke system;

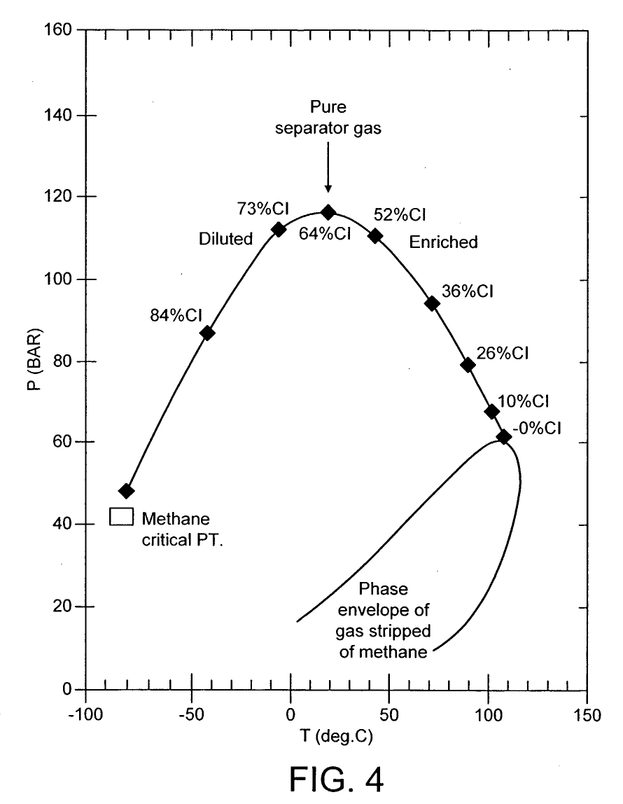

FIG. 4 Shows the effect on critical point of enriching and diluting gas from the separator system of an oil production facility;

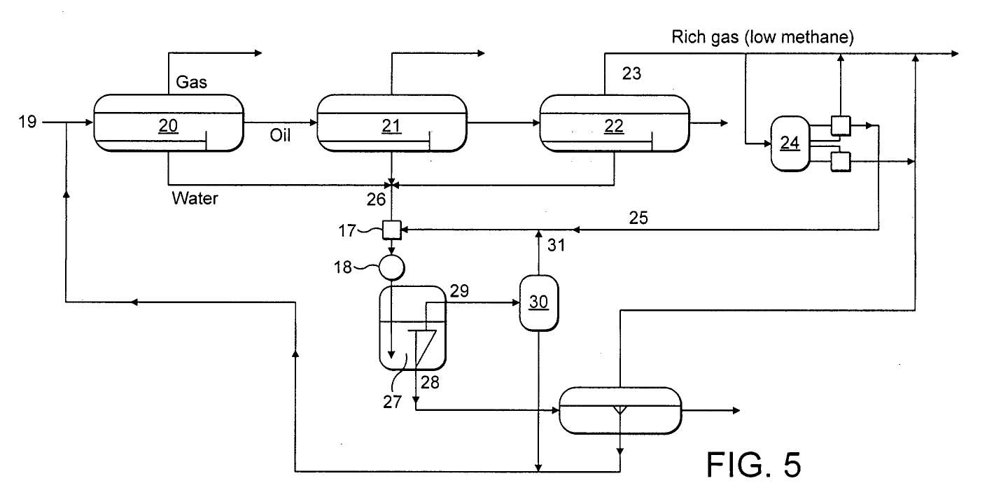

FIG. 5 Shows a schematic diagram of an oil production plant incorporating the method and apparatus of the invention;

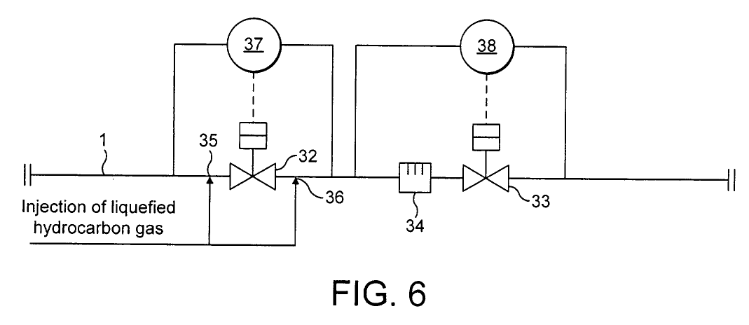

FIG. 6 Shows an arrangement of apparatus for a preferred embodiment of the invention;

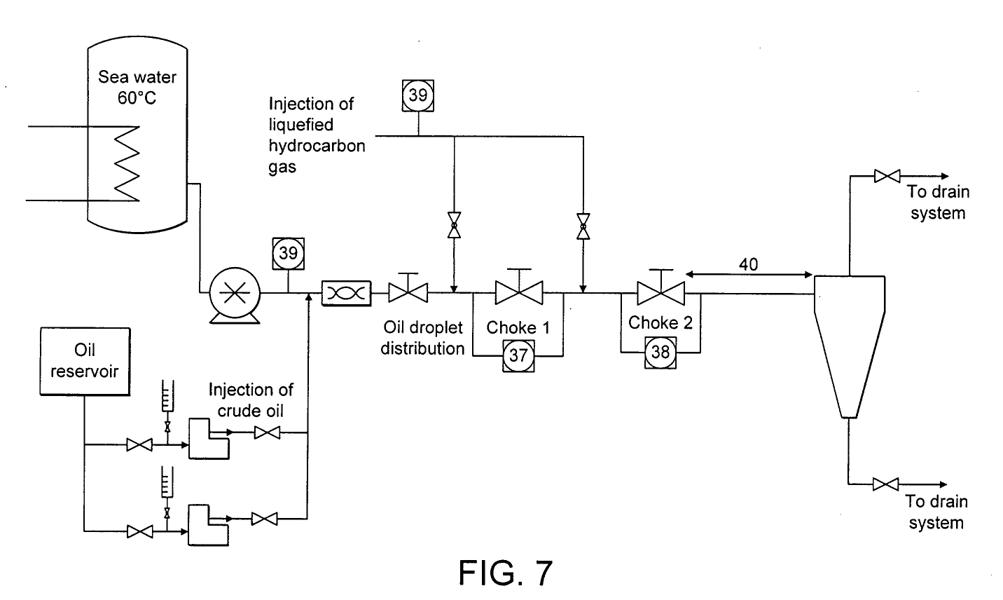

FIG. 7 Shows the arrangement of apparatus of the invention used in testing in the Examples below;

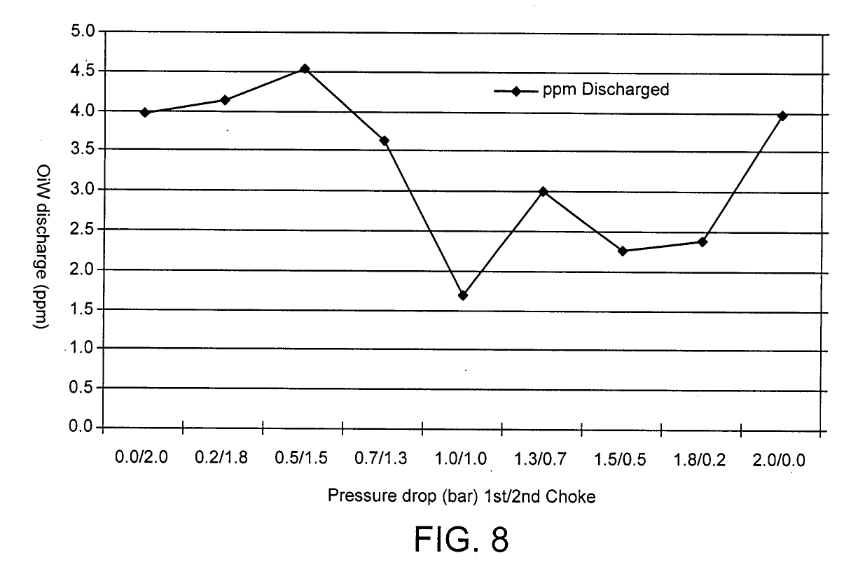

FIG. 8 Shows the effect on discharged oil by adjusting the two pressure drops in the inventive method.

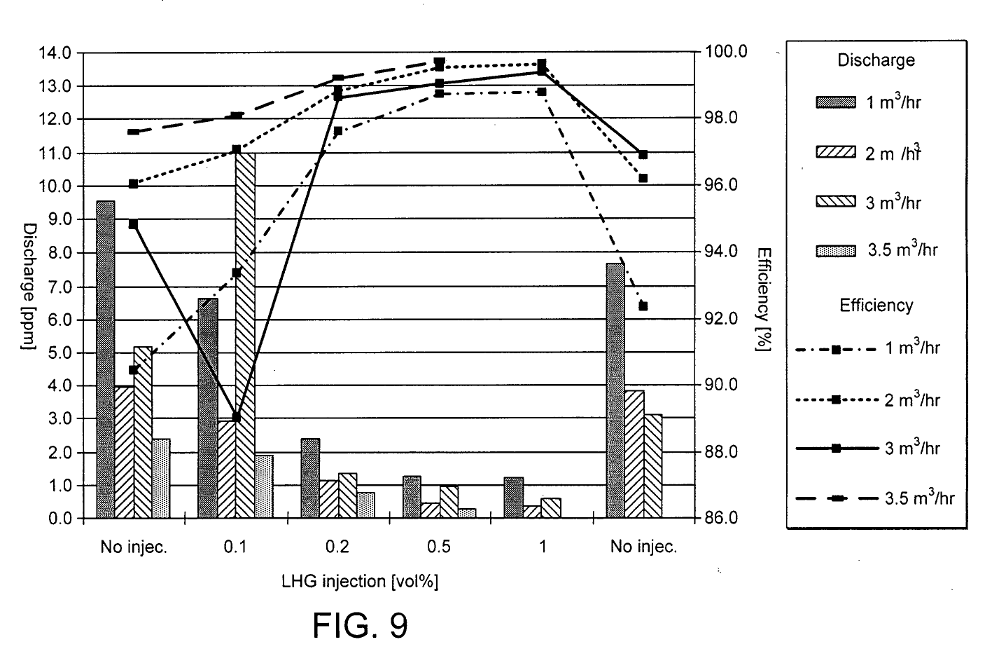

FIG. 9 Shows the efficiency of the method of the invention at varting flow rates using the apparatus of FIG. 7.

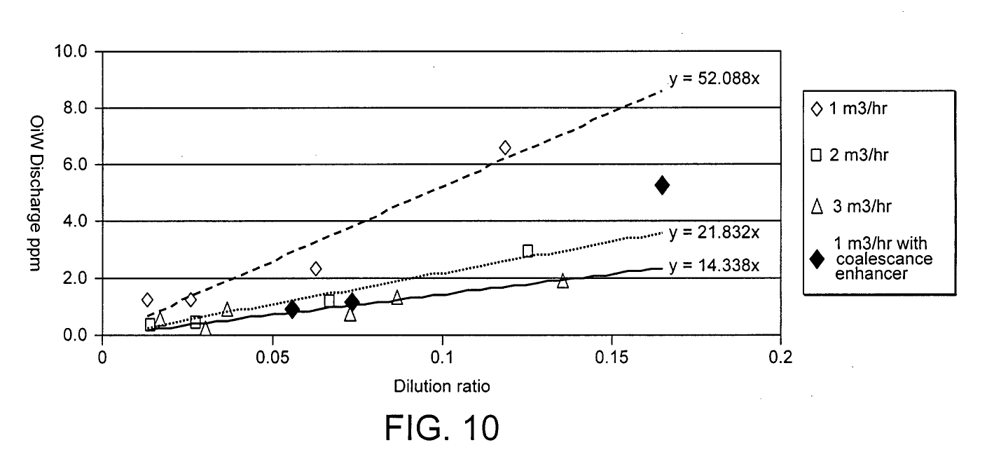

FIG. 10 Shows the effect of incorporating an optional coalescance enhancing unit at low flow rate.

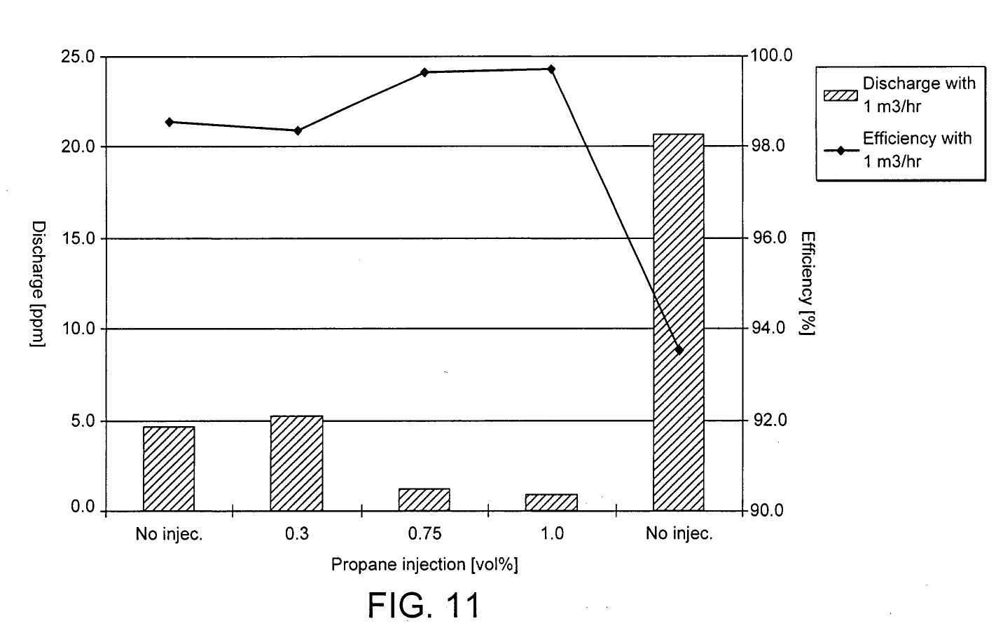

FIG. 11 Shows the results of separation by the method of the invention incorporating the optional coalescance enhancing unit.

The processes and apparatus of the present invention employ at least two pressure drops, which are typically provided by “chokes”. The term “choke”, as used herein, indicates, in its broadest form, any device capable of generating a pressure drop in flowing water. Preferably, the chokes which provide the pressure drops of the present invention will be adjustable, in that the pressure drop they provide may be altered to some extent at commissioning and/or during the operation of the method or apparatus. These chokes will preferably not simply be the typical valves and/or changes of pipe size which might introduce a pressure drop under normal operations. In particular, although individually the chokes may be of known design, the proximity of the second pressure drop to the first is of considerable significance to the invention, as indicated herein. Certain forms of chokes which might be used are described herein and include combined chokes and injectors and chokes having one or more variable size constrictions in the path of the water flow. Many other forms of chokes are, however, useable in the present invention and two “plain”, non-injector adjustable chokes in close proximity (as described herein) form the preferred embodiment of the invention.

The present invention is based upon the surprising finding of the inventor that a series of at least two chokes may be used to sequentially break up droplets of suspended organic material in a flowing aqueous phase and then coalesce the thus-generated broken droplets so as to form larger droplets which are more readily separated by differential density techniques such as in a hydrocyclone.

Without being bound by theory, it is believed that the shear stress created by the first pressure drop at the first choke serves to fragment and break up the droplets of organic material that are suspended in the aqueous phase. This breakage serves to expose a much greater surface area of the suspended phase to equilibration at the aqueous interface and thus promotes partitioning of material into the organic phase. Furthermore, the breakage of the droplets serves to disrupt any surface layer of stabilising surfactants, microscopic particulates and/or ordered shells of water molecules previously serving to minimise the energy of the organic/water interface and thus stabilise the organic droplets.

It is the inventor's non-binding theory that such disruption renders the generated droplet fragments (referred to as “broken” droplets herein) susceptible to rapid mass transfer, and particularly to efficient coalescence, for a short time (believed to be of the order of seconds) after the broken droplets are generated. This coalescence may be initiated by the further pressure drop across the second choke which, because of the nature of the broken droplets, serves not to cause any further net breakage of the droplets but, overall, to cause coalescence.

The coalescence generated by the methods of the invention is advantageous in a number of ways. Firstly, broken drops of oil and/or other organic contaminants suspended in water may be caused to fuse with suspended or broken drops of an extractant fluid such as a liquefied hydrocarbon gas. This fusion may cause the final droplets to be larger overall (have greater volume) than the original droplets and thus speed separation. Even if the final droplets are of the same size or smaller in comparison with those in the feed stream, however, the fact that many of the broken droplets will fuse with low density extractant will reduce the density of the resulting fused droplet and thus, overall, accelerate its separation from the aqueous phase due to the greater density difference.

A second advantage of the breaking and coalescence technique is in extracting dissolved organics from the aqueous phase. In particular, if the extractant is subjected to droplet breaking, the lack of hindrance at the surface of the broken droplet will, especially when combined with the larger droplet surface area, increase the rate of transfer into the organic phase. Most dissolved organic contaminants will have only a low solubility in water and a considerably higher solubility in the extractant. At equilibrium, therefore, most of the dissolved organic material will be present in the extractant phase rather than the aqueous phase. The formation of broken droplets of extractant is thus believed to speed the establishment of this equilibrium and so enhance the removal of dissolved material.

The use of two or more consecutive pressure drops to respectively break and then coalesce droplets of suspended organic material is central to the present invention. The facility of the second pressure drop to cause net coalescence is believed to be a feature of the nature of the broken droplets and the relative position of the two chokes providing the two pressure drops will thus be, to some extent, restricted by the stability of these broken drops. If too great a period is allowed between the first and second pressure drops then the broken droplets will tend to stabilise by the surface incorporation of trace surfactants (such as naturally occurring surfactants in produced water) from the bulk liquid, the addition of microscopic particles to the droplet surface and/or the formation of relatively low energy ordered shells of water around the droplets. All of these factors will tend to limit coalescence and favour further droplet breakage. In contrast, if too small a period is allowed between the first and second pressure drops then the advantageous effects of the broken droplets having a larger surface area will not be optimally exploited and extractant will be less well mixed with droplets of contaminant. In each situation, there will thus be an optimum positioning of the two pressure drops to provide maximum extraction of contaminants

The optimum positioning of the two pressure drops will readily be established by a skilled worker by reference to the teaching and examples herein. In particular, the size of droplets before the first pressure drop, between the two pressure drops and after the second pressure drop will be readily measured by techniques such as laser light scattering or software digital image analysis (see examples below). In any situation where the droplets are being provided with a net decrease in size at the first pressure drop and a net increase in size at the second pressure drop then the system is functioning in the manner of the present invention. It is not necessary that the final size is greater than the size before the first choke since other considerable advantages exist to counteract any overall droplet size decrease. In all the descriptions of the invention made herein, references to the “size” of droplets indicates the diameter of a droplet along its longest axis, or an average (especially a volume average) of such sizes as appropriate.

If the droplets are not being provided with a net decrease in size at the first pressure drop then the pressure drop is too low and should be increased. This can be carried out easily in at least two ways; adjust the first choke or increase the flow rate through this. Either of these measures can provide a greater pressure drop. Similarly, if the size of the broken droplets is so small that, even after the second pressure drop, the resulting droplets cannot be effectively separated then the pressure drop is too high and should be reduced.

If the droplets are not being provided with a net increase in size at the second pressure drop then this may also be corrected easily. There are two likely causes of this effect; either the pressure drop is outside of the desired range or the period between the first and second pressure drops is too great. Each of these factors may be corrected by a skilled worker. The pressure drop may be adjusted by means of adjusting the second choke and/or by changing the flow rate. Similarly, the period between chokes can be altered by changing their relative separation in the flow or by changing the flow rate. For any existing or desired system, the present invention may thus be made to function with no more than routine testing and adjustment.

It will generally be desirable for the present invention to be practicable over a wide range of flow rates. As a result, it is preferable that one or both (preferably both) of the first and second chokes be adjustable to correct for flow conditions at any point in time. Most desirably, a self-adjusting system will be provided to maintain a pressure drop within the desired range at all expected flow rates.

It will also be desirable for the coalescence effect at the second pressure drop to be provided over a range of flow rates. The two chokes should thus be placed in the flow at relative positions such that, at the lowest expected flow rate, the period a droplet of fluid spends between passing the first and second pressure drops should be close to the maximum which will provide effective coalescence. In this way, at any desired flow rate, coalescence will be achieved and the greatest possible period for mixing will be provided.

Obviously, by the introduction of suitable devices, such valves switching in different lengths and/or diameters of piping between the two chokes, the residence time between the two chokes at different flow rates may be independently altered so as to provide more optimally controlled conditions for any particular flow rate. This would allow, for example, a longer pipe to be switched in for higher flow rates so as to provide coalescence under all flow conditions without reducing mixing at higher flows. These and other options may be manually or automatically adjusted and will be evident to one of skill in the art.

It is desirable that the effects of the invention be achievable over a considerable range of flow rates. The methods and apparatus of the invention should desirably thus provide droplet breakage over the first pressure drop and droplet coalescence over the second pressure drop over a wide range of flow rates. This may be in the range 30 to 40 m³/hr through a 7.5 cm (3″) diameter pipe, preferably the invention will be functional over a throughput of 20 to 50 m³/hr and more preferably throughout a range of 10 to 60 m ³/hr through a 7.5 cm (3″) diameter pipe. Evidently, the effects at larger pipe diameters may be estimated by reference to the cross-sectional area of the conduit and thus these ranges equate to an average linear velocity of around 0.48 to 0.64, preferably 0.32 to 0.80 and more preferably 0.16 to 0.96 m/s. This function over a wide range of flows is only possible by the present inventor's insight that the advantages of the present invention relate to droplet size control over appropriate pressure drops in at least two stages.

By knowledge of the average linear velocity of the water between the two chokes it is also possible to estimate the time any particular droplet will take from passing the first pressure drop to passing the second. As discussed above, this time should be chosen such that the net effect of the second pressure drop is to coalesce the broken droplets provided by the first and thus result in a net increase in average particle size. This time and thus the desired separation of the chokes will be readily determinable by one having knowledge of the present invention and will depend on factors such as the type and concentration of contaminant and extractant. As a general guide, the separation of the chokes should be such that the average time spent flowing between is less than 20 seconds, preferably less than 15 seconds and most preferably less than 10 seconds. Where a range of flow rates is expected, the chokes should be so arranged as to provide a suitable interval at all expected flow rates. No minimum time between chokes is necessary for the functioning of the invention but in some cases a certain time for mixing may be desirable. It is thus expected that the separation provides a time between chokes of no less than 0.5 seconds, preferably no less than 1 second.

A key factor in the present invention will be the establishment of an appropriate pressure drop across each of the first and second chokes, preferably at a rage of flow rates. The pressure drop at the first stage will be sufficient to provide a net breakage of droplets of dispersed organic material. This will vary depending upon the flow rate, and upon the quantity and nature of the organic material dispersed. As described above, this desired pressure drop will be functionally established for any set of conditions by simple experimentation. As a guide to establishing optimal conditions, suitable pressure drops will typically be in the range 0.1 to 10 bar, e.g. 0.2 to 5 bar or 0.25 to 5 bar, preferably 0.3 to 4 bar and more preferably 0.5 to 3 bar. Although higher pressure drops function to break up the droplets, these may be shattered into such small fragments that even after coalescence they may not separate effectively. Once again, a little routine measurement of droplet size distribution and separation efficiency will suffice to determine the ideal conditions.

As indicated above, the second pressure drop will be established functionally as a pressure drop in the range of those providing net coalescence of droplets of suspended organic material under the desired conditions. As a general indication, the second pressure drop will typically be no more than 1.8 times greater than the first pressure drop. This will preferably be no more than 1.5 times and more preferably no more than 1.25 times the first pressure drop. If the second pressure drop is too high then it will tend to result in greater breakage of droplets than coalescence. The minimum for the second pressure drop will generally be no less than 0.1 times (especially 0.2 or 0.5 times) the first pressure drop, preferably no less than 0.6 times and more preferably no less than 0.75 times the first pressure drop.

The present invention relates to the mixing of a liquefied hydrocarbon extractant with water and the subsequent separation of the aqueous phase from the organic material. As used herein, the term “water” is used to indicate not only pure water but particularly contaminated water, such as produced water, and (where context allows) any dispersed and/or dissolved materials including gasses, salts, and organic materials. Thus, where “water” is described as flowing to or through some feature of the process or apparatus of the invention, this indicates also the concomitant flow of entrained materials dissolved and/or dispersed therein. This is opposed to the term “aqueous phase” or “water phase” which indicates only the continuous water phase and materials dissolved therein, rather than any dispersed organic materials.

The terms “liquefied hydrocarbon gas”, “liquefied hydrocarbon gas extractant”, “extractant” and similar are used herein to indicate a largely hydrocarbon gas or gas mixture with a bubble point such that the extractant is in the liquid phase under the pressure the temperature conditions of the separation process. Suitable gas mixtures are typically available as one of the produced streams from an oil production facility, typically having been stripped from the oil fraction in one of several 3-phase separators used at an early stage in purification. There are often 3 “stages” of these separators used consecutively to remover fractions with decreasing boiling point. Highly suitable gasses will generally be gasses or gas mixtures having a critical point around the processing and separating conditions. The most suitable gasses will generally be gasses or gas mixtures having a bubble point below the processing and separating conditions of pressure and temperature. This means that if a gas mixture separated from produced oil is used then this may need to be “enriched” (i.e. stripped of some or all of the methane content) in order to bring the phase properties to match the working temperature and pressure.

The extractant should substantially remain liquid throughout the mixing and any separation process for optimal effect. Generally, the furthest down-stream point in the method or apparatus of the present invention will be or operate at lowest pressure. In suitable embodiments, the extractant will thus be chosen to be in the liquid phase at the overflow point of the separator (e.g. hydrocyclone). This criterion will easily be tested for any proposed gas or gas mixture by routine measurement and experimentation. Where a substantial quantity of the extractant forms gas bubbles in the process then this will generaly hinder the methods of the invention, but a certain amount of gas generation may be tollerated. The extractant should thus generally form no more than 10% gas phase at the lowest pressure point in the process or apparatus. This will preferably be no more than 8% and more preferably no more than 7%.

The working temperature of a separation system might typically be 60-110° C. and 30 to 100 bar pressure. Suitable extractants are thus largely hydrocarbon mixtures which are liquid under the process conditions, such as these. Suitable liquefied gas extractants include “Natural Gas Liquefied” (NGL), which generally comprises volatile hydrocarbons with 2 or more carbon atoms. Essentially hydrocarbon gasses containing a large part C₂ to C₅ hydrocarbons are particularly suitable. These might contain, for example at least 50% C₂ to C₅ hydrocarbons, preferably 65% and most preferably 75% C₂ to C₅ hydrocarbons. It is preferable that these ratios apply to C₃ to C₅ hydrocarbons. Some methane may be present in the extractant, as may some heavier hydrocarbons. The utility of a potential extractant will be evident by comparison of the desired process conditions with the phase diagram of that mixture.

A graph showing the effect of methane concentration on critical point of a gas generated from a “second stage” three phase separator is attached hereto as FIG. 4. Since liquid phase can only be achieved up to the critical point temperature and pressure, it is evident that if higher temperatures and pressures are required, so the proportion of methane must be reduced.

The amount of extractant to be used at any stage will be dependent upon the amount of oil in the contaminated water but will generally be as low as is possible while maintaining effective separation. Typically, with oil contamination levels of up to 1000 ppm, a volume ratio of extractant to water of up to around 1.5% will be suitable. At lower contaminant levels, this may be reduced to as little as 0.1% by volume (for an input contamination of around 30 ppm for example). A typical range might thus be 0.1 to 2% by volume of water, preferably 0.2 to 1.5%, but these may be higher for heavily contaminated water, the best ratio being readily determinable by testing.

Further details of suitable gasses and gas mixtures may be found in WO 98/37941. The disclosure of this and of all citations referred to herein is hereby incorporated herein by reference.

In many of the embodiments of the present invention, an optional mixing step may be included. This is generally designated as step c). The mixing step may be included in any situation but becomes increasingly necessary with larger cross-section equipment. Step c) will thus generally be included where the cross-section of the pipe or other conduit carrying the water is greater than around 1200 cm² (equivalent to around 40 cm-16″ diameter pipe). The mixer with preferably be included where this cross-section is greater than 700 cm² (30 cm-12″ pipe) and most preferably also where the cross-section is greater than 175 cm² (15 cm -6″ pipe). Such a mixing step may be provided by any mixer known in the art but will generally be provided by a static mixing device since these provide no moving parts requiring servicing or maintenance. It may be desirable to include some or more mixing effect at lower flow rates where less turbulence is provided at the first choke, or where the first choke is operating close to the lower end of its desirable range of pressure drops. The mixer may thus be such that the presence or amount of mixing may be controlled so as to achieve the most desirable mixing conditions in any particular situation. These will become evident upon routine experimentation.

Many aspects of the present invention may optionally include steps or corresponding parts (i) to (iv) as indicated above. In some situations, these steps will be inherent in the design and installation of the process or apparatus while in other situations, active and/or dynamic monitoring and/or adjustment will be desirable to provide optimal separation conditions.

Where any aspect of the invention is to be practiced in situations where the water flow rate will vary only to a small extent then steps i) and iii) may be carried out at the design and installation stage and/or upon commissioning the process/apparatus. In this situation, the adjustments at steps ii) and iv) may occur by choice and use of a fixed choke for either or both of the first and second chokes. In such a case, the fixed choke will have an appropriate pressure drop over the range of operational flow-rates as determined at the design or commissioning stage. Similarly, where the flow rate will vary insignificantly during appropriate periods, the assessment and adjustments of steps i) to iv) may be carried out as part of routine maintenance on a yearly, monthly or weekly basis, using chokes which are appropriately adjustable over this timescale.

In contrast, where the process of the invention is to be employed in a situation of continuously variable flow rate over a wide range, a system of real-time or near real-time measurement and adjustment corresponding to steps i) to iv) will be appropriate. Such real-time adjustment may be provided by a purely mechanical system, such as one in which the difference in pressure across the choke automatically adjusts the flow of water therethrough using a pre -adjusted mechanical or electromechanical feed-back mechanism. Alternatively, a complete system of sensors and actuators may be connected to a computer interface so as to provide monitoring and adjustment of the performance of the entire system, either entirely under software or with appropriate human intervention at any stage. Evidently, in these and many other ways, the effectiveness of the processes of the invention may be maintained over a wide range of flow rates.

In a further aspect of the method and apparatus of the invention, additional coalescance of the droplets of contaminant hydrocarbon and/or extractant may be provided after the second pressure drop. Such an affect may be provided by a coalescance enhancing unit and is particularly effective at low flow rates. Colescance enhancers may comprise, for example, low density fibres, sometimes referred to as “coalescing internals” which are held in the flow and act to increase droplet size. In this aspect, the invention thus provides a method comprising exposing the flow of water with entrained droplets of conaminant and/or extractant to a coalescing unit after the second pressure drop and before any separation. A corresponding apparatus comprises at least one coalescing unit between the second choke and any separator. The coalescing unit should preferably comprise a plurality of fibres held in the water flow. A particularly suitable coalescing unit is the Cyclotech PECT-F coalescing unit.

The function on the invention may additionally be enhanced by the use of at least one emulsion breaker. This may be added to the flow of water at any stage, particularly after the first pressure drop, at or after the second pressure drop and/or before any separation step. Suitable emulsion breakers are common in the art and may help to coalesce the broken droplets, especially after the first pressure drop. A corresponding apparatus having an injector suitable for injecting an emulsion breaking agent is provided. This unit is preferably positioned upstream of the second pressure drop, at the second pressure drop, downstream of the second pressure drop or upstream of the separator.

The above aspects of the invention involve the use of a liquefied hydrocarbon gas extractant for the separation of dissolved and/or dispersed contaminants from water, and these aspects are preferred. In an alternative aspect of the invention, however, the process may be carried out in the absence of any extractant hydrocarbon. In this case, the droplet fragmentation followed by coalescence may result in net fusion of the existing suspended droplets of hydrocarbon (i.e. of dispersed oil contaminant) and thus improve their average size and separation. Furthermore, the broken droplets caused at the first pressure drop may serve to expose a greater surface area of dispersed hydrocarbon to the water phase and thus enhance the absorption of dissolved organic contaminants into the existing dispersed oil. In this way, extraction of oil from produced water may be enhanced even in the absence of the equipment needed to introduce the extractant. A corresponding apparatus not including any injector for extractant forms a further alternative aspect of the invention.

The processes and apparatus of the present invention employ at least two pressure drops by means of “chokes”, and by means of these the behaviour of droplets of suspended organic phase is controlled. The term “choke” as used herein indicates any device capable of generating a pressure drop in flowing water, as indicated herein. This choke will preferably only have the function of providing a pressure drop in the flowing water, but may also have other functions. Two choke types suitable for use in the present invention are shown schematically in FIGS. 1 and 2.

FIG. 1a shows a schematic cross-section of a combined choke and extractant injection system. In this, contaminated water flowing along flow pipe (1) enters a region where this pipe is surrounded by a housing (2) having an inlet (3) for extractant, which is then contained in reservoir (4). As the contaminated water passes under pressure through nozzle (5), a constriction in the junction between housing (2) and the continuation of the flow pipe (1) generates a region of lower pressure which draws in extractant from reservoir (4). The apparatus thus generates a pressure drop and a concomitant injection of extractant fluid. Chokes of this type form one of the preferred first chokes for providing a combined injection of extractant and first pressure drop.

FIG. 1b shows a variant of the choke in which is additionally provided an adjustable nozzle control (51), by which the flow through the first choke may be adjustably restricted. In this way, and by control over the pressure of the extractant in reservoir (4), the pressure drop and proportion of extractant to water may be independently controlled to allow compensation for varying flow rates.

FIG. 2 show a schematic cross-section of a choke not having any injector function. This type of choke is particularly suited for use as the second choke to provide the second pressure drop, or as the first choke where the injection of extractant is provided before and/or after but not simultaneously with the first pressure drop. In FIG. 2, contaminated water enters at point (10) along flow -pipe (1) and reaches a point at which a generally cylindrical, conical or spherical housing (7) joins thereto, containing correspondingly shaped adjustable elements (8) and (9). The flow of water is constricted through entry-ports (11) and (12) of the respective adjustable elements (8) and (9). Only one entry port is illustrated in the figure but evidently a system of complementary holes, slits or perforations may be provided in the adjustable elements by which the flow may be adjusted by offset against the body (7) of the apparatus in the case of the first adjustable element (8) or against the other adjustable element (9). Having passed the entry ports, the water then flows through the central cavity (13) and exits through a set of exit ports (14) and (15) provided in adjustable elements (9) and (8) respectively. The exit ports may also provide control over the pressure drop and may be similar or dissimilar to inlet ports (11) and (12). The lower pressure water exits at position (16).

Evidently, a simple modification of the choke shown schematically in FIG. 2 could be used to introduce extractant into the central space (13) and thereby allow this choke also to act as a combined choke and injector system.

Two possible arrangements of apparatus for the present invention are shown in FIG. 3. FIG. 3a shows a combined injector and first choke (17) generally corresponding to FIG. 1 in line with a second choke (18) generally corresponding to FIG. 2. A more preferred embodiment is shown in FIG. 3b, in which two standard chokes (18) are provided in serise.

In the context of an oil production facility, a layout of suitable apparatus including that of the present invention is indicated in FIG. 5. Specifically, oil from the formation is provided at point (19) and successively enters 3-phase separators (20), (21) and (22). The gas produced from these is progressively richer and that produced from the third separator is taken off at point (23), optionally stripped of further methane at enricher (24) before being supplied to the combined first choke and injector (17) via pipe (25). The water phase leaving the bottom of one or more of the float-separators (20 to 22) enters first choke (17) via pipe (26). After the first pressure drop, the water and entrained extractant flows through second choke (18) and into hydrocyclone (27). The water from the hydrocyclone underflow exits through pipe (28) for any further treatment steps and discharge. The extractant from the hydrocyclone overflow (29) is routed to flash drum (30), where the high-boiling components are removed and returned to the oil stream at (19) and the extractant is re-used, re-entering pipe (25) at position (31).

A highly preferred arrangement in which two adjustable chokes are controlled to provide two pressure drops within the desired ranges is shown in FIG. 6. Water flowing along pipe (1) encounters a first choke (32) and then a second choke (33) optional mixer (34) is provided between. Extractant is injected before the first choke (35) and/or between chokes (36) and the pressure drop at each is measured and controlled by controll units (37) and (38).

The present invention will now be further described by reference to the following non-limiting examples.

### EXAMPLE 1

### Use of Two Choke System

Produced water from the three phase separator of an oil production facility was routed through a combined first choke and injector, where a first pressure drop was provided, and a second choke providing a second pressure drop. The outlet from the second choke was passed to a hydrocyclone where the organic and aqueous phases were separated.

In the two-choke setup, when the pressure drop over each of the two chokes was maintained at 0.5 bar or over, high separation efficiency, measured as residual oil, was noted. When the pressure drop was less than 0.2 bar over the first choke then the efficiency was significantly lower and equivalent to that of the single choke system at the same total pressure drop.

### EXAMPLE 2

### Automatic Flow Rate Compensation

Digital image analysis particle size equipment is installed to sample the water flow upstream of the first choke, between the two chokes and downstream of the second choke. The analysis software is configured to distinguish oil droplets from extractant droplets by optical density. Flow meters are also installed at each sample point. The software is configured such that the second choke always provides a pressure drop equal to the first pressure drop.

The size of oil droplets and of all dispersed organics is analysed, as is the flow at each stage. The oil droplet size at the first two points and the total organics droplet sizes at stages two and three are compared. The software is configured to react to an decrease in flow at the first point or a lack of decrease in oil particle size over the first pressure drop by increasing the pressure drop at the first choke. The software is further configured to react to a high proportion of small particles at the second choke by decreasing the pressure drop at the first choke.

### EXAMPLE 3

### General

Tests as below were carried out using the Produced Water Test Facility (PWTF) at the Petroleum Research Laboratories (PRL) at Norsk Hydro's Research Centre Porsgrunn.

The PWTF is able to simulate various types of produced water by injecting raw oil into a seawater flow and control droplet size distributions by varying pressure across a choke valve. The oil/water system created by the choke valve enters a test section. in this case the dual choke treatment process. All signals from the PWTF (flow. temperature and pressure) are stored in the central data logging system of PRL.

A sketch of the test rig is shown in FIG. 7. As with previous figures. the pressure drop monitors accross chokes 1 and 2 are designated (37) and (38) respectively. Flow monitors (39) measure the flow of water and hydrocarbon extractant. Distance (40) between the second choke and the hydrocyclone was a minimum of 5 metres. The required minimum distances between the mixing and hydrocyclone liner is included in the sketch.

The test system consisted of a liquefied hydrocarbon gas (LHG—consisting largely of propane) injection system with feed taken from a pressure tank. The condensate (LHG) was injected through a quill into the water phase. either upstream the first choke or between the two chokes. and mixed with the “produced water” prior to entering the hydrocyclone for hydrocarbon—water separation.

For the tests below. a “produced water” having an oil in water contamination of 300 ppm was used as feed stream and 1.0 Vol % of LHG condensate was injected. A water flow 4 m3/hr was provided through the system to a 30 mm hydrocyclone separator. To control the oil droplet distribution and simulate offshore conditions a KPS HE1 hydrocyclone liner was used as a reference due to the offshore test experience with this liner.

The level of oil in the water discharged from the above system without injection of LHG (comparative standard) was 20 ppm.

3.1 LHG condensate spillover and Oil in water (OiW) discharge was measured under the conditions described above for various pressure drops over the two individual chokes. The LHG was injected prior to the first choke and the total pressure drop over the two chokes was maintained at 2.0 bar.

The resulting data are shown in the table below and represented in FIG. 8.

| Choke pressure drops | | |
|---|---|---|
| 1st/2nd | Spillover | ppm Discharged |
| 0.0/2.0 | 70 | 4.0 |
| 0.2/1.8 | 73 | 4.1 |
| 0.5/1.5 | 80 | 4.5 |
| 0.7/1.3 | 64 | 3.6 |
| 1.0/1.0 | 30 | 1.7 |
| 1.3/0.7 | 53 | 3.0 |
| 1.5/0.5 | 40 | 2.3 |
| 1.8/0.2 | 42 | 2.4 |
| 2.0/0.0 | 70 | 4.0 |

It is apparent from the above table and FIG. 8 that the twin choke configuration yielded significant separation improvement. The best results were seen the pressure drop over the 2nd choke was no more than 50% greater than the pressure drop accross the first choke.

3.2 Two tests with condensate injected between the chokes yielded the following results under conditions as described above.

| Pressure drop | | |
|---|---|---|
| choke1/choke 2 | Spillover | Discharge |
| 1.0/1.0 | 40 | 2.3 |
| 1.5/0.5 | 80 | 4.5 |

The results again showed a significantly enhanced extraction of oil from the water when compared with the system lacking condenste injection and equivalent or superior results to use of a single pressure drop.

3.3 A single test with was made under the conditions above with the twin choke at a total pressure drop of 1 bar and pressure ratio choke1/choke2 of 0.5/0.5. This test yielded a spillover of 45 ppm. residual discharge of 2.5 ppm.

This experiment indicated a highly effective removal of dispersed oil at a total pressure drop of bar where the two chokes were operating at equal pressure drops.

3.4 The extraction of dissolved components (i.e. naphthalene) was studdied for experiments 3.1 to 3.3 described above. The removal of naphthalene was found to be directly related to the maximum pressure drop over a single choke. This maximum extraction was found irrespective of whether the higher pressure drop was accross the the first or second choke. Equilibrium level of naphthalene extraction was reached when the pressure drop over any one choke approached 2 bar. This result supports the belief that droplet breakage over the choke system strongly enhances the extraction of dissolved components even where dispersed components are extracted at an equivalent level.

### EXAMPLE 4

The test rig used in Example 3 was used to examine the efficiency of the OiW removal at a variety of flow rates and with a variety of levels of condensate injection. The arrangement of the test equipment was as in Example 3 but the hydrocyclone liner used was 1 20 mm Cyclotech B20 C. 100 ppm OiW feed stream was used. Pressure drops of 1.8 and 0.2 bar were used accross the first and second chokes respectively.

The results of the experiment are shown in FIG. 9. It can be seen that at 0.2 vol % injection and higher, a dramatic increase in OiW removal is provided at all flow rates. A discharge level of 2 ppm or lower can easily be achieved by this method, giving an oil removal efficiency of 98% or greater.

### EXAMPLE 5

The use of a coalescance enhancing system downstream of the second choke was investigated as a further improvement to the separation system at low flow rates. The apparatus used in Example 4 was set up with pressure drops of 1.8 and 0.2 bar and an input stream having 100 ppm dispersed oil.

The level of oil discharged was plotted as a function of the oil:extractant dilution ratio, with the slope of the resulting line representing the extractant spillover from the hydrocyclone.

As expected from the results of Example 4, the slope at low flow (1m3 per hour) was greater than the slope at high flow (3 m3 per hour). By addition of “PECT-F” (RTM) low density coalescing internals into the inlet chamber of the hydrocyclone, droplet growth was promoted and the resulting oil discharge at low flow rate reduced.

The results of this experiment are shown in FIG. 10, in which the solid diamonds represent the results using the coalescance enhancing system and the open diamonds are comparative results without the coalescance enhancer. This indicates an advantage in use of a coalescance enhancer at low flow rates.

### EXAMPLE 6

The setup of Example 5 was used to examine the comarison between the separation at 1 m³/hour with and without the coalescance enhancer. Injections of 0.3, 0.75 and 1% LHG were made into a feed stream containing 320 ppm OiW. The resulting discharge levels were equivalent to the output without coalescance in spite of the feed contamination being more than 3 times as great.

The results are shown in FIG. 11 and may be compared with the 1 m ³/hour results in FIG. 9. (solid bars in FIG. 9).

1) A method for mixing an extractant comprising liquefied hydrocarbon gas into a flow of hydrocarbon containing water, said method comprising;
a) introducing said liquefied hydrocarbon gas extractant into said water whereby to provide water having entrained droplets comprising said extract and/or said hydrocarbon;
b) subjecting said water to a first pressure drop whereby to fragment said entrained droplets
c) optionally, mixing said water and said liquefied hydrocarbon gas whereby to promote distribution of said liquefied hydrocarbon gas in said water; and
d) subsequently subjecting said water having entrained droplets to a second pressure drop, whereby to coalesce the entrained droplets therein.

2) The method of claim 1 wherein said first pressure drop is provided by a first choke.

3) The method of claim 1 wherein said second pressure drop is provided by a second choke.

4) A method of claim 1 additionally comprising the steps of;
i) assessing a first rate of flow of water at around the point of the first pressure drop;
ii) adjusting the first pressure drop by reference to the assessed first rate of flow of water, whereby to maintain the effect of breaking up said entrained droplets of dispersed extractant and/or hydrocarbon at the first pressure drop;
iii) assessing a second rate of flow of water at around the point of the second pressure drop;
iv) adjusting the second pressure by reference to the assessed second rate of flow of water, whereby to maintain the effect of coalescing said entrained droplets of dispersed extractant and/or hydrocarbon at the second pressure drop.

5) The method of any of claim 1 additionally comprising, after step d), separating said entrained hydrocarbon droplets from the water phase using at least one separator.

6) A method for removing contaminant organic material comprising at least one hydrocarbon from water, said method comprising mixing said water with an extractant according to the method of claim 1 followed by separation of said extractant by means of at least one separator.

7) The method of claim 5 wherein said at least one separator comprises a separator which operates by density difference.

8) The method of claim 7 wherein said separator which operates by density difference is a hydrocyclone.

9) The method of claim 1 wherein the average time taken for said water to flow between said first pressure drop and said second pressure drop is less than 20 seconds.

10. The method of claim 1 wherein said first pressure drop and said second pressure drop are in the range 0.1 bar to 10 bar.

11) The method of claim 1 wherein said second pressure drop is no more than 1.5 times said first pressure drop.

12) The method of claim 1 wherein said extractant comprises a hydrocarbon gas or hydrocarbon gas mixture having a bubble point below the conditions of said method.

13) The method of claim 5 wherein said separator has an outlet pressure and an outlet temperature and wherein said extractant is liquid at said outlet temperature under said outlet pressure.

14) The method of claim 13 wherein said outlet temperature is 60 to 110° C. and said outlet pressure is 30 to 100 bar.

15) The method of claim 5 further comprising the step of further coalescing said entrained droplets after said second pressure drop and prior to said separation.

16) An apparatus comprising a conduit suitable for accepting a flow of water, optionally containing dispersed droplets of organic contaminants, the apparatus further comprising;
a) an injector suitable for introducing a liquefied hydrocarbon gas extractant into said flow of water in the form of dispersed droplets of extractant;
b) a first choke capable of providing a first pressure drop;
c) optionally a mixer;
d) a second choke capable of providing a second pressure drop.
wherein said first and second pressure drops are provided such that in use the droplets of extractant and/or contaminant are broken as a result of passing through the first pressure drop and are coalesced as a result of passing through the second pressure drop.

17) An apparatus suitable for separating dissolved and/or dispersed organic contaminants from water, said apparatus the apparatus of claim 16 and additionally;
e) a separator suitable for separating said liquefied hydrocarbon gas from said water.

18) An apparatus as claimed in claim 16 additionally comprising;
i) a device capable of reacting to a first rate of flow of water through the first choke;
ii) a device capable of adjusting the first choke by reference to the reaction provided at step i);
iii) a device capable of reacting to a second rate of flow of water through the second choke;
iv) a device capable of adjusting the second choke by reference to the reaction provided at step iii);
whereby in use the first and second pressure drops are maintained such that the droplets of extractant and/or contaminant are broken as a result of passing through the first pressure drop and are coalesced as a result of passing through the second pressure drop over a wide range of flow rates.

19) The apparatus of claim 17 wherein said at least one separator comprises a separator which operates by density difference.

20) The apparatus of claim 19 wherein said separator which operates by density difference is a hydrocyclone.

21) The apparatus of claim 16 wherein in use the average time taken for said water to flow between said first choke and said second choke is less than 20 seconds.

22) The apparatus of 16 wherein said first choke and said second choke are each capable in use of providing a pressure drop are in the range 0.1 bar to 10 bar.

23) The apparatus of claim 16 wherein in use the pressure drop across said second choke is no more than 1.5 times the pressure drop across said first choke.

24) The apparatus of claim 17 wherein in use said separator has an outlet pressure and an outlet temperature and wherein said extractant is liquid at said outlet temperature under said outlet pressure.

25) The apparatus of claim 24 wherein said outlet temperature is 60 to 110° C. and said outlet pressure is 30 to 100 bar.

26) The apparatus of claim 17 further comprising a coalescance enhancer provided between said second choke and said separator.
